(19) United States
(12) Patent Application Publication
(10) Pub. No.: US 2022/0332007 A1
(43) Pub. Date: Oct. 20, 2022

(54) UNIT FOR MACHINING GROOVES AND SEPARATING CUTS, HAVING A CHIP-GUIDING FUNCTION

(71) Applicant: HOMAG GmbH, Schopfloch (DE)

(72) Inventors: Martin CALMBACH, Horb-Dießen (DE); Harald RIEGER, Waldachtal (DE)

(21) Appl. No.: 17/626,799

(22) PCT Filed: Jul. 14, 2020
(86) PCT No.: PCT/EP2020/069860

§ 371 Date: Jan. 12, 2022

(30) Foreign Application Priority Data
Jul. 16, 2019 (DE) 10 2019 119 230.7

(51) Int. Cl. B27G 19/08; B27B 5/18; B27B 5/29; B27G 3/00; B23D 59/00

(52) U.S. Cl. CPC B27G 19/08; B27B 5/187; B27B 5/29; B27G 3/00; B23D 59/006

(57) ABSTRACT

A unit for machining a workpiece, in particular for machining grooves and separating cuts therein, said workpiece preferably consisting at least partially of wood, wood-based materials, metal materials or plastic, has a main body (1), a machining tool (2) which is mounted, in particular rotatably mounted, on the main body (1), wherein the machining tool (2) has a first portion (3) which is configured such that, during machining of the workpiece (10), it is able to penetrate into the workpiece (10), and a guiding device (4) which is arranged in the region preferably next to the machining tool (2) and is configured such that a medium is able to flow along, preferably through, the guiding device (4), wherein the guiding device (4) has at least one opening (5) at a lower end portion thereof. The guiding device (4) is configured such that the medium is able to flow out of the opening (5) substantially towards the first portion (3) of the machining tool (2), and/or the guiding device (4) has an extraction device.

### TECHNICAL FIELD

The present invention relates to a unit which can be used, for example, in the field of machining grooves and separating cuts of a workpiece that preferably consists at least partially of wood, wood-based materials, metal materials or plastic.

### PRIOR ART

In the field of machining grooves and separating cuts of workpieces made of wood or wood-like materials using a machining tool, in particular a circular saw blade, climb machining is often practised to prevent chipping on the workpiece surface. Due to the direction of rotation of the circular saw blade, particles, in particular chips and dust which are separated from the workpiece, are catapulted at high speed along and/or out of the machined groove. This creates the problem of considerable dust and chip contamination in the area around the machine. Such dust and chip contamination may lead to a considerable reduction in machine performance as well as affect the operator of the machine.

Systems for machining grooves and separating cuts often have an extraction hood with which particles produced during machining are to be extracted. Such an extraction hood is, for example, known from EP 0 489 397 A1. However, due to the high speed at which the chips are catapulted along the groove, they can hardly, if at all, be deflected by negative pressure out of the groove into the extraction system and extracted. With narrow grooves, there is the additional problem of chips getting stuck in the groove which results in insufficient extraction.

To enable more effective particle and/or chip removal, in prior art machining systems a groove is alternatively initially climb-milled in a first work step with a low cutting depth and thus low chip removal to prevent chipping on the surface. Subsequently, the second work step takes place conventionally at groove depth to achieve chip removal upwards into the extraction hood. This leads, however, to the problem of increased machining time and possibly increased wear on the tool.

In the field of hand-held circular saws and circular saw benches, a riving knife is used which is similar to the (chip) guide element disclosed here. Such a riving knife is, for example, known from EP 0 012 404 A1. However, the riving knife known in the prior art only prevents the saw blade from jamming during the separating cut and has no function for improved dust and/or chip removal which means that the problem of dust and chip contamination continues to exist.

In addition, tools with special tooth geometry, by means of which airborne chips are to be directed, are known in prior art. In this case, the problem is that this technology is only possible with wide grooving tools and also only to a limited extent.

### PRESENTATION OF THE INVENTION

In light of the known prior art, the object of the invention is to provide a unit for machining, in particular for machining grooves and separating cuts of a workpiece that preferably consists at least partially of wood, wood-based materials, metal materials or plastic with which the dust and chip contamination in the area around the unit is minimised.

These objects are achieved by the unit according to claim 1. Advantageous developments of the invention emerge from the subclaims.

The unit according to the invention for machining a workpiece, in particular for machining grooves and separating cuts therein, said workpiece preferably consisting at least partially of wood, wood-based materials, metal materials or plastic, has a main body, a machining tool which is mounted, in particular rotatably mounted, on the main body, the machining tool having a first portion which is configured such that, during machining of the workpiece, it is able to penetrate into the workpiece, and a guiding device which is arranged in the region preferably next to the machining tool and is configured such that a medium is able to flow along, preferably through, the guiding device, the guiding device having at least one opening at a lower end portion thereof. The guiding device is configured according to the invention such that the medium is able to flow out of the opening substantially towards the first portion of the machining tool, and/or according to the invention the guiding device has an extraction device.

One advantage of the unit according to the invention is that the unit is configured such that a stream of dust and/or chips, which are separated from the workpiece during machining of said workpiece and fly along the groove at high speed, is deflected such that the stream is guided out of the groove, away from the workpiece. In this case, the stream is deflected such that the chips are guided towards an optionally arranged extraction hood. In addition, the machining of grooves and separating cuts can be carried out in one operation without dust or chip contamination which minimises the machining time and tool wear. Another advantage of the unit according to the invention is that the unit is configured in such a manner that dust which settles at the base of the groove is effectively removed from the groove.

The main body of the unit may be an element to which the machining tool is attached. The main body may further have an interface via which the main body can be integrated into a machine environment, such as a CNC machining centre. Such a machine environment may in turn have a plurality of different units for machining workpieces.

The machining tool may be any machining tool suitable for machining, in particular for machining grooves and separating cuts of a workpiece that preferably consists at least partially of wood, wood-based materials, metal materials or plastic. Such machining tools may be, for example, a circular saw blade or a milling cutter which are rotatably mounted on the main body or a machining tool or a laser operated via ultrasonics which are otherwise mounted on the main body. In addition, further machining tools suitable for the machining operations described above, also known in prior art, are conceivable.

The machining tool is mounted on or attached to the main body in such a manner that at least a portion of the machining tool can engage with the workpiece.

The machining tool has a first portion which is configured such that, during machining of the workpiece, it is able to penetrate into the workpiece. The first portion may be a portion of the machining tool which is engaged with the workpiece and/or descends into the workpiece during machining of said workpiece.

For example, when machining the groove of a flat, plate-like workpiece, the first portion is the portion of the machining tool which is hidden by the workpiece when the flat, plate-like workpiece is viewed horizontally, level with the workpiece plane. In the case of a circular saw blade as the machining tool, the first portion of the machining tool is not to be understood as a portion which is located in a stationary region of the circular saw blade and rotates with the circular saw blade and thus would periodically engage with the workpiece. Rather, the first portion of the machining tool is to be understood as the portion which is engaged with the workpiece and/or penetrates or descends into the workpiece at any time or moment in time during machining of the workpiece. Consequently, in the case of machining grooves using a circular saw blade, the first portion is shaped like a segment of a circle.

Correspondingly, in the case of machining by means of laser radiation, the first portion of the machining tool may be understood as part of the laser beam which penetrates into the workpiece during machining of the workpiece.

The guiding device is arranged in the region preferably next to the machining tool and is configured such that the medium is able to flow along, preferably through, the guiding device. In this case, the guiding device is arranged in the region of the machining tool in such a manner that it is operatively connected to the machining tool. Operatively connected may be understood in this context as the guiding device being configured in particular in such a manner that it can exert an effect on the particles separated from the workpiece during machining of the workpiece with the machining tool.

For example, the guiding device may be arranged in a lateral region with respect to the machining tool. The guiding device is preferably arranged next to the machining tool. In the case of a circular saw blade as the machining tool, the guiding device may be arranged, for example, substantially in the plane of the circular saw blade. The guiding device can thus be arranged upstream or downstream of the machining tool. In particular, the guiding device can be arranged downstream of the machining tool, viewed in the feed direction. The guiding device may be any device configured to guide the medium in a flowable manner. In particular, the guiding device may have one or more tube-like elements but also elements that do not have a circular or round cross-section, for example a square or rectangular cross-section.

The medium can flow along the guiding device, it being not necessary for the guiding device to completely enclose the medium. The medium can preferably flow through the guiding device, the guiding device completely enclosing the medium such that the medium can only leave the guiding device at points provided for this purpose. In particular, the medium may be particles, air, a fluid and/or a mixture thereof.

The guiding device has at least one opening at the lower end portion thereof. The lower end portion of the guiding device may be an end portion of the guiding device which is located in the region of, in the vicinity of or next to the machining tool, in particular next to the first portion of the machining tool. In particular, the guiding device may have more than one end portion, in particular two end portions, the end portion which is located nearest or nearer to the first portion of the machining tool being the lower end portion of the guiding device.

The lower end portion of the guiding device has at least one opening, i.e. one or more openings. In this case, the opening may have any cross-sectional shapes, in particular a round or angular cross-sectional shape. In addition, the opening may be of any size. For example, the opening may have a circular cross-sectional shape of any diameter. In the case of more than one opening, the openings may in particular have different shapes and/or cross-sectional shapes.

Optionally, one or more openings in the lower end portion of the guiding device may face the first portion of the machining tool.

The guiding device is configured such that the medium is able to flow out of the opening substantially towards the first portion of the machining tool, and/or the guiding device has the extraction device. The formulation “and/or” stands for either “and” or “or” and therefore contains three alternatives. The formulation “and” means that the guiding device is both configured such that the medium is able to flow out of the opening substantially towards the first portion of the machining tool, and that the guiding device has the extraction device. The formulation “or” means that the guiding device is either configured such that the medium is able to flow out of the opening substantially towards the first portion of the machining tool, or that the guiding device has the extraction device.

The guiding device is configured in such a manner that the medium is able to flow along, preferably through, the guiding device and is able to flow out of the opening substantially towards the first portion of the machining tool. The medium may have a plurality of particles, for example particulates, air molecules, fluid particles, which in their entirety form the medium. Such a particle located in the medium, which moves with the medium, flows in particular initially along, preferably through, the guiding device before leaving the guiding device through the at least one opening at the lower end portion of the guiding device.

According to the invention, the guiding device is configured such that the medium moves substantially towards the first portion of the machining tool after leaving the guiding device. In particular, the guiding device is configured such that the medium does not move away from the first portion of the machining tool after leaving the guiding device. In this case, the guiding device may have a specific shape which is configured such that it guides the medium in a certain direction and/or specifies a certain direction for the medium so that the medium moves substantially towards the first portion of the machining tool after leaving the guiding device through the opening.

The formulation “substantially” means here that the medium, or individual particles thereof, have a speed which can be described by a speed vector, the speed vector having at least one component that points towards the first portion of the machining tool. The component of the speed vector that points towards the first portion of the machining tool may preferably be the largest component of the speed vector.

In the case of machining grooves and with a circular saw blade as the machining tool, the first portion of the machining tool, which is engaged with the workpiece as described above, may be shaped like a segment of a circle. In this case, the speed vector of the medium or of individual particles of the medium may, after leaving the guiding device and/or even before leaving the guiding device, have a component which points towards this segment of a circle or the first portion of the circular saw blade. The speed vector may also have a component which points towards the base of the groove. The medium can then be deflected and/or reflected on the base of the groove and continue to move towards the first portion of the machining tool.

As a result of the medium moving from the opening substantially towards the first portion of the machining tool, individual particles of the medium may strike and/or hit particles which are separated from the workpiece during machining of the workpiece and are catapulted along the groove at high speed. The particles are deflected due to this collision of the medium with the particles. This process is comparable to an elastic impact of two particles/bodies.

The collision causes the particles separated from the workpiece to be deflected upwards, i.e. in a direction away from the workpiece, where they can be captured and extracted by an optional extraction hood. This results in substantially less to no dust and chip contamination in the area around the machine.

The guiding device may comprise an extraction device, it being possible for the extraction device to be any device which has and/or can generate a negative pressure compared to the ambient air pressure of the unit. The extraction device may be a negative pressure chamber, the negative pressure chamber being created by other means. In this case, the negative pressure of the extraction device may be strong enough to draw in and/or extract particles which are separated from the workpiece by the machining tool during machining of the workpiece. It may be possible to discharge the particles through the guiding device, in particular contrary to a flow direction of the medium.

Due to the fact that the guiding device comprises the extraction device, said extraction device can capture and extract very small particles separated from the workpiece, such as dust, which may settle at the base of the groove.

In some preferred embodiments, the guiding device has at least one channel, the channel having the opening at the lower end portion of the guiding device.

The channel may have a tubular shape, preferably with a round cross-section. However, the channel may also have other shapes with other cross-sectional shapes, such as an angular cross-sectional shape.

The channel has the at least one opening at the lower end portion of the guiding device. For example, the channel may extend along the entire guiding device. In particular in the case of a tubular channel, one opening of the tubular channel or tube may constitute the opening of the guiding device. Instead of or in addition to this opening, the channel may have one or more openings in a lateral portion of the channel which preferably faces the machining tool.

The guiding device may have one or more channels, each of these channels having an opening in each case. The cross-sectional shapes of the channels and/or openings may be different. For example, at least one channel may serve to guide the medium such that it is able to flow and to flow out through the opening of the channel, and at least one other channel may serve to comprise the extraction device. In the case where at least one channel comprises the extraction device, the negative pressure of the extraction device causes particles which have been separated from the workpiece to enter the channel through the opening of the channel and to be guided away from the workpiece through the channel. In this way, the guiding device can both make the medium flow out substantially towards the first portion of the machining tool and also comprise the extraction device. As a result, this can ensure a compact design of the guiding device. Preferably, the at least one channel which guides the medium and the at least one channel which comprises the extraction device can be arranged in such a way that they do not have an adverse effect on each other. In particular, the medium is able to flow out of the at least one opening of the channel in such a manner that it is not captured and extracted by the extraction device.

In some preferred embodiments, the lower end portion of the guiding device has at least one nozzle.

In particular, the nozzle may be arranged at or in the opening of the guiding device and/or the channel, or may constitute the opening of the guiding device and/or the channel. Likewise, a plurality of channels may have the nozzle. In this case, the nozzle may be of any shape of nozzles known in the prior art. In particular, the nozzle may have a round cross-section and taper towards the lower end portion of the guiding device. As a result, the medium is able to flow out of the nozzle or opening at a higher speed compared to use without a nozzle. As a result, individual particles of the medium can strike and/or hit particles, which are separated from the workpiece during machining of the workpiece, at higher speed. This makes it possible for particles to be effectively diverted and/or deflected.

In some preferred embodiments, the unit further comprises a guide element which is arranged in the region preferably next to the machining tool and is configured such that particles, in particular chips, which can be separated from the workpiece with the machining tool during machining of said workpiece, can be guided along a deflection direction after separation from the workpiece, the deflection direction being substantially oblique to a reference direction, the reference direction being defined as a direction from the first portion of the machining tool to a second portion of the machining tool which is opposite the first portion of the machining tool.

In this case, the guide element is arranged in the region of the machining tool in such a manner that it is operatively connected to the machining tool. Operatively connected may be understood in this context as the guide element being configured in particular in such a manner that it can exert an effect on the particles separated from the workpiece during machining of the workpiece with the machining tool. For example, the guide element may be arranged in a lateral region with respect to the machining tool. The guide element is preferably arranged next to the machining tool.

The guide element can be arranged upstream or downstream of the machining tool.

In the case of a circular saw blade as the machining tool, the guide element may be arranged, for example, substantially in the plane of the circular saw blade. As described above, particles, in particular chips, are catapulted along the groove at high speed during machining of the workpiece, in particular when machining grooves. The guide element which is preferably arranged next to the machining tool, for example the circular saw blade, is configured such that the particles, in particular the chips, can be guided along a deflection direction by the guide element, the deflection direction being substantially oblique to a reference direction. In this context, the reference direction is defined as a direction from the first portion of the machining tool to a second portion of the machining tool which is opposite the first portion of the machining tool.

As described above, the first portion of the machining tool is the portion which penetrates into the workpiece during machining of the workpiece. According to the definition above, the second portion of the machining tool is located opposite the first portion thereof. Consequently, in the case of the circular saw blade as the machining tool, the second portion is located substantially in a direction along the diameter of the circular saw blade opposite to the first portion.

The deflection direction is substantially oblique to the reference direction, i.e. to the direction from the first portion to the second portion of the machining tool. In this context, the formulation “oblique” means that the deflection direction has a certain angle to the reference direction which is preferably less than 90°. The term “direction” in “reference direction” is to be understood vectorially and means that the reference direction is not tied to a specific location and/or a specific part of the machining tool. That is to say, the reference direction is generally a direction which may point away from the surface of the workpiece, in particular may be perpendicular to the surface of the workpiece. In this context, the formulation “substantially” means that the particles, in particular the chips, do not have to be guided strictly along one and the same deflection direction but that there may also be a certain variance of the directions in which the particles can be guided.

According to the invention, the guide element is configured such that the particles, in particular the chips, can be guided along the deflection direction by the guide element. In particular, the particles, particularly the chips, if they are catapulted along the groove at high speed, may collide with the guide element and/or strike and/or hit the guide element. In particular, the guide element may have sloping edges and/or surfaces, the particles striking these surfaces and/or edges at an oblique angle, i.e. not perpendicular to the surface. Due to this collision, the particles, in particular the chips, may be deflected and guided and/or directed out of the groove. As a result, the particles, in particular the chips, are directed upwards and may be captured and extracted by an optionally arranged extraction hood, which leads to less dust and chip contamination in the area around the machine.

In some preferred embodiments, the guide element is configured such that a lower end thereof, in a first position of the guide element, is arranged at a position which is located along the reference direction within a region in which the first portion of the machining tool is located along the reference direction.

The lower end of the guide element, for example, may be an outer edge or an outer surface of the guide element. The first position of the guide element is determined by the position of the lower end of the guide element along the reference direction. In particular, the position of the lower end of the guide element is not fixed in a direction perpendicular to the reference direction.

As described above, the first portion of the machining tool may be understood as the portion which is hidden by the workpiece when the workpiece is viewed horizontally, level with the workpiece plane.

With a circular saw blade as the machining tool and a flat, plate-like workpiece, when viewed in this manner, the first portion of the machining tool is shaped like a segment of a circle which has a certain extension in the direction parallel to the workpiece surface and perpendicular to the workpiece surface, i.e. substantially parallel to the reference direction. In an imaginary two-dimensional Cartesian coordinate system, in which the one axis is parallel to the workpiece surface and the other axis is perpendicular thereto, the extension of the first portion of the machining tool, thus the segment of a circle in the case of the circular saw blade, can be described by a certain range of values with regard to the axis parallel to the workpiece surface and a certain range of values with regard to the axis perpendicular to the workpiece surface, i.e. substantially parallel to the reference direction.

In the first position of the guide element, the lower end of the guide element is in a position which is located along the reference direction within the region in which the first portion of the machining tool is located along the reference direction. That is to say, in the first position of the guide element, the lower end of the guide element may be in a position which is located within the range of values that describes the extension of the first portion of the machining tool with regard to the axis perpendicular to the workpiece surface, i.e. parallel to the reference direction.

In the case of a circular saw blade as the machining tool when machining grooves, the first portion of the circular saw blade may be described as a segment of a circle which has a certain extension along the reference direction, i.e. substantially in a direction perpendicular to the workpiece surface, the maximum extension corresponding to the depth of the groove. According to the invention, the lower end of the guide element is thus located within the groove in the first position of the guide element.

It is thus ensured that the guide element is located within the groove, at least in sections, during machining of the workpiece by the machining tool. This enables particles, especially chips which are separated from the workpiece and catapulted along the groove at high speed, to strike or hit a portion of the guide element and as a result be directed out of the groove, preferably away from the workpiece. In this way it is possible to ensure that the dust and chip contamination in the area around the machine is minimised.

In some preferred embodiments, in the first position of the guide element, a distance along the reference direction between the lower end of the guide element and an end of the machining tool, which forms part of the first portion of the machining tool and is furthest away, along the reference direction, from a mounting portion of the machining tool at which the machining tool is mounted on the main body, is less than 5 mm, preferably less than 3 mm, especially preferably less than 1 mm.

According to the invention, the distance between the lower end of the guide element and the end of the machining tool is defined along the reference direction, i.e. in the case of a flat, plate-like workpiece, along a direction substantially perpendicular to the workpiece surface.

The end of the machining tool is part of the first portion thereof. That is to say, the end of the machining tool engages with the workpiece, or descends into the workpiece. Furthermore, the end of the machining tool is arranged furthest away, along the reference direction, from a mounting portion of the machining tool at which the machining tool is mounted on the main body. In the case of a circular saw blade as the machining tool, the mounting portion of the machining tool coincides with the centre point of the circular saw blade and the reference direction runs substantially along the diameter of the circular saw blade and, as regards a flat, plate-like workpiece surface, perpendicular to the workpiece surface. In this case, the end of the machining tool is the part of the circular saw blade that is currently machining the workpiece. In the case of machining grooves, this is the part which engages with the base of the groove.

Thus, when machining grooves, a distance of the lower end of the guide element from the base of the groove is less than 5 mm, preferably less than 3 mm, especially preferably less than 1 mm. This ensures that the guide element descends into the groove until just before the base of the groove. In this way, particles, in particular chips, which are separated from the workpiece during machining of the workpiece and are catapulted along the groove at high speed, can be almost completely removed from the groove and/or directed out of the groove. In addition, effective extraction is thus achieved by means of the extraction device of the guiding device.

In some preferred embodiments, the guide element can be controlled and/or adjusted from the first position into at least one second position, the lower end of the guide element being arranged in the at least one second position at a position which lies along the reference direction outside the region in which the first portion of the machining tool is located along the reference direction.

The guide element can be controlled and/or adjusted from the first position into at least one second position by suitable means and/or apparatuses which are connected to the guide element. For example, the guide element may be brought into the at least one second position by pivoting. It is further conceivable that the guide element may be brought into the at least one second position by a movement combining translation and rotation. In this case, the guide element may be gradually or continuously controllable and/or adjustable. The guide element may in particular be controllable and/or adjustable from the first position not only into a second position but into a plurality of positions.

The lower end of the guide element is located in the at least one second position at a position which lies along the reference direction outside the region in which the first portion of the machining tool is located along the reference direction. In the case of machining grooves, the second position of the guide element, as described above in connection with the description of the first position of the guide element, is a position at which the guide element is not located within the groove. As the guide element is not in the groove in the at least one second position, unlike the first portion of the machining tool, the unit can also be used for conventional machining and/or non-continuous grooves.

In some preferred embodiments, the control and/or adjustment of the guide element from the first position into the at least one second position takes place manually and/or automatically, the control and/or adjustment of the guide element taking place preferably pneumatically and/or electrically.

The control and/or adjustment of the guide element may take place manually, for example by adjusting the position of the guide element by hand depending on the type of machining of the workpiece. The control and/or adjustment of the guide element preferably takes place automatically. In this way, the unit according to the invention may be used, for example, in a machine environment such as in a CNC machining centre, and may machine a plurality of grooves for example, some of which may be continuous and others non-continuous, the guide element travelling to the required position automatically in each case. The guide element may further have a sensor system which, for example, measures the distances from the guide element to the workpiece in order to thus control and/or adjust automatic displacement of the guide element.

The control and/or adjustment of the guide element preferably takes place pneumatically and/or electrically. With pneumatic control and/or adjustment, the unit may additionally have feeds, in particular compressed air feeds. The control and/or adjustment of the guide element may take place in particular linear to the machining tool or rotatably about the mounting portion of the machining tool. A linear cylinder or rotary cylinder may be used accordingly.

In addition, the guide element may be exchanged in the at least one second position.

In some preferred embodiments, the guiding device is arranged next to the guide element, the at least one opening preferably being arranged next to the lower end of the guide element. The guiding device is preferably integrated in the guide element, the at least one opening preferably being arranged in the lower end of the guide element and/or in a lateral surface portion of the guide element which preferably faces the machining tool and is preferably located in the vicinity of the lower end of the guide element.

In this case, the formulation “and/or” means that the opening may be arranged either in the lower end of the guide element or in the lateral surface portion of the guide element, or that the opening may extend over a portion that connects the lower end and the lateral surface portion of the guide element together, or that the at least one opening may be arranged in the lower end of the guide element and in the lateral surface portion of the guide element.

The guiding device may be arranged both on the sides and upstream or downstream of the guide element as long as the guiding device together with the guide element can engage in a groove of the workpiece. The same may apply in particular in the case of the at least one channel and/or the at least one nozzle of the guiding device.

The guiding device is preferably integrated into the guide element, the guide element being able to have a certain thickness and/or width such that the medium is able to flow through the guiding device within the guide element. In particular, the guide element may in itself constitute a channel of the guiding device. The at least one opening of the guiding device is preferably arranged in the lower end of the guide element and/or in a lateral surface portion of the guide element which preferably faces the machining tool and is preferably located in the vicinity of the lower end of the guide element. For example, the at least one opening may be implemented as at least one drilled hole. Furthermore, the at least one nozzle of the guiding device may also be arranged in the lower end of the guide element and/or in a lateral surface portion of the guide element which preferably faces the machining tool and is preferably located in the vicinity of the lower end of the guide element.

In the event that the at least one opening of the guiding device is arranged in a lateral surface portion of the guide element which preferably faces the machining tool, the at least one opening may optionally be located at a position of the lateral surface portion of the guide element which, when the guide element is in the first position, i.e. descends into the groove, is located inside the groove (i.e. over the entire height of the groove) and/or outside thereof (such that the medium, for example, is able to flow into the groove from above the groove).

It is further conceivable that two guiding devices may be provided, one guiding device being arranged next to the guide element, the at least one opening preferably being arranged next to the lower end of the guide element, and the other guiding device being integrated in the guide element, the at least one opening preferably being arranged in the lower end of the guide element and/or in a lateral surface portion of the guide element which preferably faces the machining tool and is preferably located in the vicinity of the lower end of the guide element.

Due to the combination of guide element and guiding device, particles, in particular chips which are catapulted along the groove at high speed after separation from the workpiece, are directed out of the groove substantially in a direction in which they can be captured and extracted by an optional extraction hood, not only due to the interaction with the guide element but additionally due to the interaction with the medium of the guiding device.

The fact that the at least one opening and/or the at least one nozzle of the guiding device is/are preferably arranged in the lower end of the guide element and/or in a lateral surface portion of the guide element, which preferably faces the machining tool and is preferably located in the vicinity of the lower end of the guide element, not only allows the medium to exit substantially towards the first portion of the machining tool, i.e. against the stream of chips, and thus effectively deflects the chips upwards and/or out of the groove. Similarly, the flow of the medium prevents chips from settling at the base of the groove or jamming laterally between the edge of the groove and the guide element.

In some preferred embodiments, the guide element is configured as a riving knife.

In particular, the guide element may have the structural characteristics and/or functions of a riving knife known from the prior art. As a result, the guide element not only serves to remove the particles, in particular the chips, from the groove but is also suitable for preventing the machining tool from jamming in the workpiece.

In some preferred embodiments, the unit further comprises a cover device which is arranged in the region of the guide element, preferably with the cover device partially enclosing the machining tool, the cover device being configured such that the particles can be guided along the deflection direction after separation from the workpiece.

For example, the cover device may be a metal sheet which is shaped such that it can partially enclose the machining tool. It is also conceivable that the cover device can additionally partially enclose a portion of the guide element. In particular, the cover device is arranged in the region of the guide element in such a manner that the cover device is operatively connected to the guide element and/or to the machining tool. Operatively connected may be understood in this context as the cover device being configured in particular in such a manner that it can exert an effect on the particles separated from the workpiece during machining of the workpiece with the machining tool. The cover device may be movable with the guide element or also separate therefrom with respect to the machining tool.

According to the invention, the cover device is configured such that the particles, in particular chips, can be guided along the deflection direction by the cover device. In particular, the particles, particularly the chips, if they are catapulted along the groove at high speed, may collide with the guide element which engages in the groove. However, it is conceivable that a few particles are already catapulted out of the groove before colliding with the guide element or fly past the guide element. It is further conceivable that a few particles are not deflected as intended along the deflection direction after colliding with the guide element. For example, this may occur due to interaction of the chips with each other. Due to the fact that the cover device is arranged in the region of the guide element and partially encloses the machining tool, the particles which have not been deflected along the deflection direction as intended can hit or strike the cover device.

In particular, the cover device may have sloping edges and/or surfaces similar to the shapes of the guide element, the particles striking these surfaces and/or edges at an oblique angle, i.e. not perpendicular to the surface. As a result of this collision, the particles, in particular the chips, may be directed upwards and may be captured and extracted by an optionally arranged extraction hood, which leads to even more effective reduction of the dust and chip contamination in the area around the machine.

In some preferred embodiments, a medium flow of the medium comprises in particular a particle flow, air flow, fluid flow and/or a flow of a mixture thereof.

The medium flow may be selected depending, for example, on the type of machining tool and/or of the workpiece to be machined. For example, if a workpiece is machined in such a manner that particles, in particular chips, of large size occur, a medium flow consisting of larger and/or heavier particles may be selected in order to direct the chips properly in the deflection direction. In this way, regardless of the type of machining tool and/or the workpiece to be machined, it is possible to ensure low dust and chip contamination in the area around the machine.

In some preferred embodiments, the machining tool comprises a circular saw blade.

In the case of the circular saw blade, the guiding device, the guide element and the cover device are arranged according to the invention on the side of the circular saw blade in the direction of which, starting from the first portion of the circular saw blade, the particles, in particular chips, are catapulted at high speed after separation from the workpiece. Optionally, as already described several times, the unit may comprise an extraction hood known from the prior art.

In some preferred embodiments, the unit further comprises at least one, preferably at least two supports to a C-axis or to a spindle housing and/or a hollow shank taper, feeding of the medium taking place via the at least one, preferably via the at least two supports to a C-axis or to a spindle housing and/or via the hollow shank taper.

Feeding of the medium via the support(s) and/or the hollow shank taper enables a compact design of the unit since a supply line of the medium is held in a fixed position. The supply line of the medium may further comprise one or more hoses which are arranged between the guiding device of the unit and the support(s) and/or the hollow shank taper. For example, a hose may be routed through a central hole through the hollow shank taper. In this case, the hose/hoses may be integrated into the main body of the unit or may extend outside thereof.

The at least one, preferably at least two supports to a C-axis or to a spindle housing may be at least one, preferably at least two C-axis bolts.

In addition, the invention relates to an exchangeable, preferably automatically exchangeable unit, in particular a saw unit, which comprises the unit according to a previous embodiment, the unit being exchangeable into a 2-axis machining head (5-axis head) via the at least one, preferably via the at least two supports and/or via the hollow shank taper, and the guide element being automatically adjustable to a contour of the workpiece according to a position of a C-axis and/or at least one additional axis, which is parallel or identical to a rotational axis of the machining tool, and a position of an A-axis of the 2-axis machining head (5-axis head).

The exchangeable unit may in particular be suitable for being exchanged via a tool changer via the at least one, preferably via the at least two C-axis bolts and/or via the hollow shank taper, in a machine environment, in particular in a CNC machining centre. In this case, the C-axis bolt(s) engage(s) into the C-axis of the 2-axis machining head (5-axis head) in order to be rotatable about the C-axis. As the guide element can be automatically adjusted to a contour of the workpiece according to a position of the C-axis and a position of the A-axis of the 2-axis machining head (5-axis head), the exchangeable unit is highly flexible and the automatic adjustability of the guide element reduces the machining time. Furthermore, it is conceivable that the unit itself has a C-axis, for example referred to as the “C2-axis”, or a coupling. Flexibility of the unit may thereby be further increased. Alternatively, an element may have such a C2-axis or coupling, it being possible to connect the unit to this element via the interface of the main body and thus incorporating it into a machine environment. For example, the element may be a spindle nose of a spindle.

In addition, it may be possible to exchange the exchangeable unit of the embodiments described via a hollow shank taper interface.

The units of the embodiments described may further comprise a sensor system. In this case, the sensor system may serve to monitor and/or adjust and/or control the position of the guide element and/or of one or more characteristics of the medium, such as pressure, flow rate, composition and the like.

In the preceding presentation of the invention, some aspects of the invention were explained based on the example of machining grooves using a circular saw blade as the machining tool. The present invention, however, is by no means limited to machining grooves using a circular saw blade as the machining tool but encompasses any aspects which fall within the scope of the appended claims.

### BRIEF DESCRIPTION OF THE FIGURES

Further preferred features and advantages of the invention emerge from the following description of the figures.

FIG. 1 shows a schematic illustration, from the side, of a preferred unit for machining a workpiece.

FIG. 2a shows a front view of a guide element of the unit from FIG. 1.

FIG. 2b shows a cross-sectional view of the guide element from FIG. 2a along the line A-A.

FIG. 2c shows a perspective view of the guide element of the unit from FIG. 1, in which a guiding device that is integrated in the guide element is marked.

FIG. 2d shows a perspective view of the guide element of the unit from FIG. 1 from below.

FIG. 3 shows a configuration of the unit from FIG. 1, in which the guide element is located in a second position.

FIG. 4 shows a configuration of the unit from FIG. 1, in which the unit additionally comprises a cover device.

FIG. 5 shows a schematic perspective view of a preferred unit for machining a workpiece, in which the unit is attached to a 2-axis machining head (5-axis head).

### DETAILED DESCRIPTION OF THE PREFERRED EMBODIMENTS

Preferred embodiments of the invention are explained in detail below based on the associated figures in order to describe the invention with the help of illustrative examples. Further modifications of certain individual features described in connection with this may be combined with other features of the embodiments described to form further embodiments of the invention.

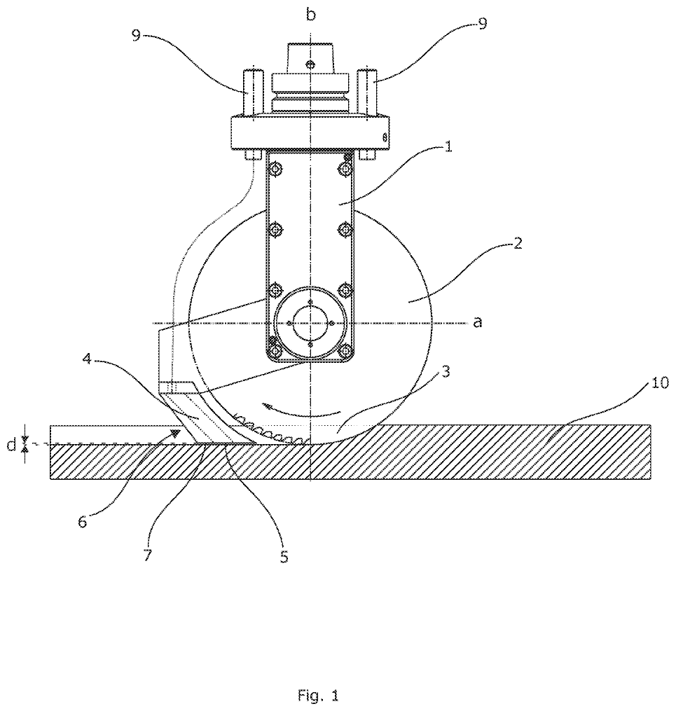

FIG. 1 shows a schematic illustration, from the side, of a preferred unit for machining a workpiece. The unit comprises a main body 1 which is substantially cuboid in shape. The cuboid main body 1 has a lower end portion and an upper end portion, the lower end portion being located closer to a workpiece 10 than the upper end portion. On the upper end portion of the main body 1, the main body 1 has an interface and a plurality of C-axis bolts 9 via which the unit can be used in a machine environment, for example in a CNC machining centre. A machining tool 2, in the case of FIG. 1 a circular saw blade 2, is rotatably mounted on the lower end portion of the main body 1.

FIG. 1 shows a situation in which the unit is used for machining a groove of a workpiece in climb mode. In this case, the circular saw blade 2 rotates clockwise and the workpiece 10 is moved to the left or the unit is moved to the right (for example in a CNC machining centre). The circular saw blade 2 comprises a first portion 3 which, as shown in FIG. 1, penetrates into the workpiece 10 during machining of the workpiece 10. In FIG. 1, the segment of a circle of the circular saw blade 2 which is delimited by the dotted line corresponds to the first portion 3 of the circular saw blade 2. As can be seen in FIG. 1, the largest extension of the first portion 3 of the circular saw blade 2 along a direction b corresponds exactly to the groove depth.

The unit further comprises a guide element 6 which is arranged next to the circular saw blade 2. The guide element 6 comprises an upper end portion, which has an upper end, and a lower end portion, which has a lower end 7. In addition, the unit comprises a holding apparatus, one end of which is connected to the upper end portion of the guide element 6 and the other end of which is connected to the lower end portion of the main body 1. The guide element 6 is thereby held in its position.

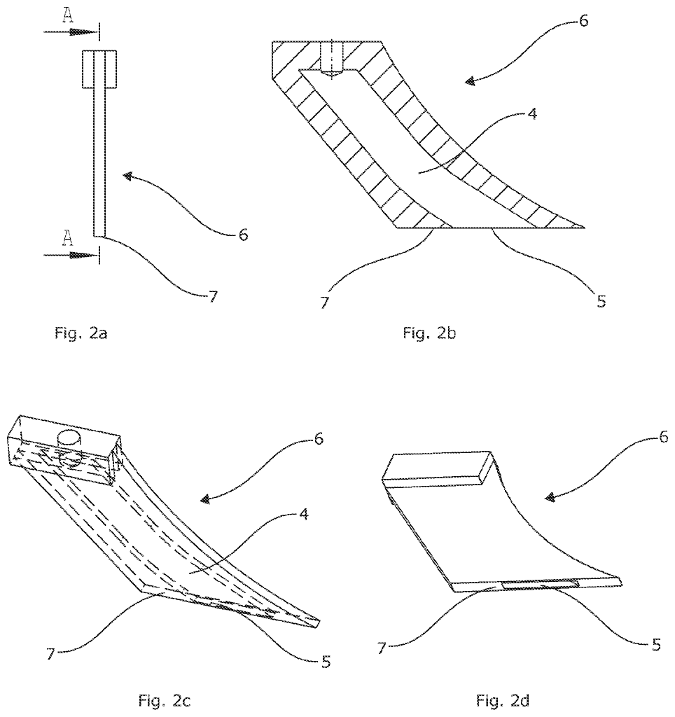

In FIG. 1, the guide element 6 is located in a first position in which the guide element 6 also penetrates into the groove next to the first portion 3 of the circular saw blade 2. Referring to FIG. 1, the reference direction is parallel to the direction b from the first portion 3 of the circular saw blade 2 to a second portion of the circular saw blade 2 which is opposite the first portion 3 of the circular saw blade 2. The lower end 7 of the guide element 6 is located in the first position of the guide element 6 along the reference direction (along the direction b) in a position which is located within a region that corresponds to the extension of the first portion 3 of the circular saw blade 2 along the reference direction (along the direction b). Here, according to the invention, a distance d between the lower end 7 of the guide element and the base of the groove is less than 5 mm, preferably less than 3 mm, especially preferably less than 1 mm. The guide element 6 will be described in detail with reference to FIGS. 2a-2d.

A guiding device 4 which extends from the upper end of the guide element 6 to the lower end 7 of the guide element 6 is integrated in said guide element 6. The guiding device 4 has an inlet opening at an upper end portion thereof and an opening 5 at a lower end portion thereof which is arranged in the lower end 7 of the guide element 6. A medium is guided into the guiding device 4 through the inlet opening of the guiding device 4. In this case the medium is fed through corresponding lines, for example via a C-axis bolt 9 of the unit. In the case of FIG. 1, the medium is fed in via the left-hand C-axis bolt 9. Inside the guiding device 4, the medium flows from the inlet opening in the upper end portion of the guiding device 4 to the opening 5 in the lower end portion of the guiding device 4 where it exits from the guiding device 4.

As can be seen in FIG. 1, the guiding device 4 runs substantially parallel to a tangential direction of a tangent to the circular saw blade in the region of the guide element 6. Due to this configuration of the guiding device 4, the flow of the medium is routed and/or influenced in such a manner that the medium flows out of the opening 5, i.e. after leaving the opening 5, substantially towards the first portion 3 of the circular saw blade 2. In other words, the movement of individual particles of the medium moving with the medium is expressed by a speed vector which has a component that points towards the first portion 3 of the circular saw blade 2. Thus the medium in the base of the groove flows against a stream of chips, consisting of chips which are separated from the workpiece 10 during machining of the workpiece 10 and are catapulted along the groove, i.e. in FIG. 1 towards the left along the direction a, at high speed. In this regard, the medium hits individual chips or collides with them, thus directing the chips upwards out of the groove where they can be captured and extracted by an optional extraction hood. This results in substantially less dust and chip contamination in the area around the machine.

FIG. 2a shows a front view of the guide element 6 of the unit from FIG. 1. The lower end 7 of the guide element 6 is located at the bottom in FIG. 2a. The upper end portion of the guide element 6 has holding elements on both sides thereof, which may be connected to the one end of the holding apparatus of the unit.

FIG. 2b shows a cross-sectional view of the guide element 6 from FIG. 2a along the line A-A. The lower end 7 of the guide element 6 has a flat surface which, in the first position of the guide element 6, is substantially parallel to the surface of the workpiece 10 which forms the base of the groove.

The side facing the circular saw blade 2 (right side in FIG. 2b) has a curved shape or a curved surface. The slope of the curved surface, from the lower end 7 towards the upper end of the guide element 6, increases with respect to the plane in which the lower end 7 of the guide element 6 is located. Due to this configuration, chips which are separated from the workpiece 10 during machining of the workpiece 10 and are catapulted along the groove (substantially along the direction a in FIG. 1) at high speed hit the curved surface at a relatively shallow angle (measured with respect to the curved surface). As a result, the chips are not guided and/or directed back into the groove by crashing into the curved surface of the guide element 6 but are guided and/or directed along the curved surface of the guide element 6 out of the groove along the deflection direction. The chips can then be captured and extracted by an optionally arranged extraction hood which leads to less dust and chip contamination in the area around the machine.

As can further be seen in FIG. 2b, the guiding device 4 is integrated inside the guide element 6. The opening 5 of the guiding device 4 is located in the lower end 7 of the guide element 6. The inlet opening, through which the medium flows into the guiding device 4, is located in the upper end portion of the guiding device 4 and the upper end portion of the guide element 6. The shape of the guiding device 4 substantially follows the shape of the guide element 6.

Compared to the upper end portion of the guiding device 4, the lower end portion of the guiding device 4 has a gentler slope with respect to the plane in which the lower end 7 of the guide element 6 is located. As a result, the medium flowing through the guiding device 4 is guided even more effectively towards the first portion 3 of the circular saw blade 2 and thus against the chips catapulted along the groove.

FIGS. 2c and 2d show perspective views of the guide element 6 of the unit from FIG. 1, in which the guiding device 4 that is integrated in the guide element 6 is marked in FIG. 2c. Although the guiding device 4 is shown in the figures with only one channel in each case, the guiding device 4 may have a plurality of channels, one of which can be configured, for example, as an extraction device to extract dust arising during machining of the workpiece 10.

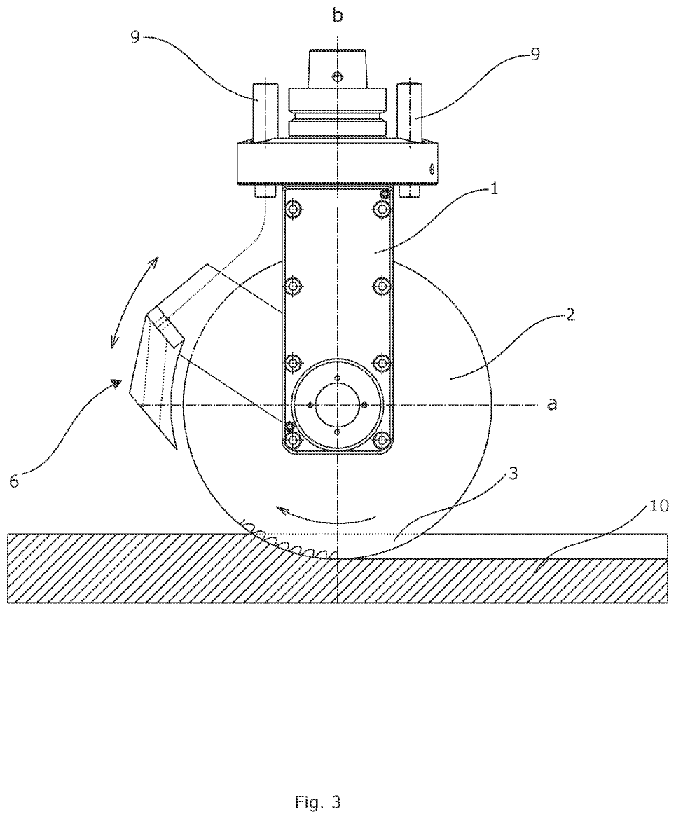

FIG. 3 shows a configuration of the unit from FIG. 1, in which the guide element 6 is located in a second position. The situation shown in FIG. 3 shows conventional machining of a groove. In this case, the circular saw blade 2 rotates clockwise and the workpiece 10 is moved to the right or the unit is moved to the left (for example in a CNC machining centre). The configuration of the unit shown in FIG. 1 would be unsuitable for such machining, as the guide element 6 would bump against the workpiece 10. As can be seen in FIG. 3, the control and/or adjustment of the guide element 6 between the first and the second position of the guide element 6 takes place rotatably about the mounting portion of the circular saw blade 2. More precisely, the holding apparatus of the guide element 6 pivots clockwise about the mounting portion of the circular saw blade 2, whereby the guide element 6 is moved as well. In the second position of the guide element 6, the lower end 7 of the guide element 6 is not located inside the groove of the workpiece 10. In this way, the unit can also be used to produce non-continuous grooves.

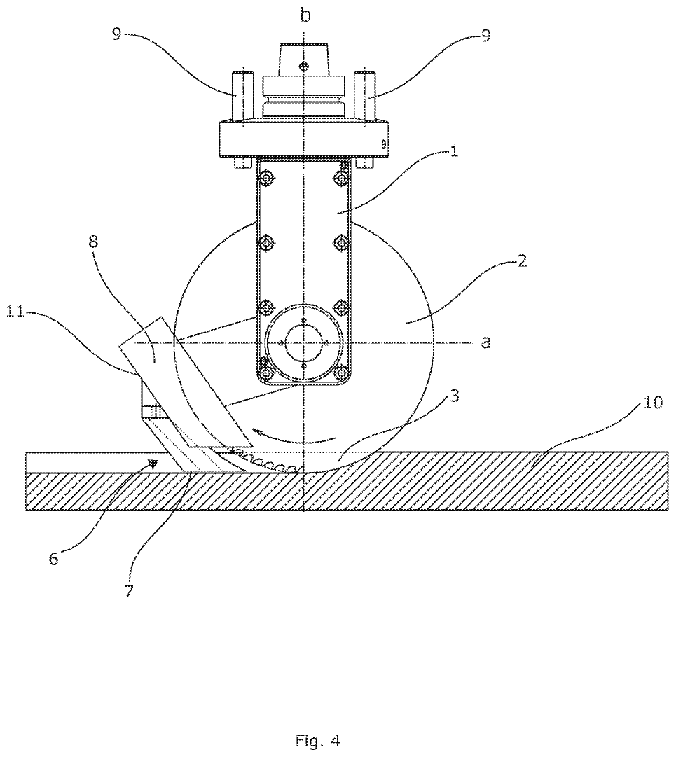

FIG. 4 shows a configuration of the unit from FIG. 1, in which the unit additionally has a cover device 8. The cover device 8 is configured such that it partially encloses both the circular saw blade 2 and the guide element 6. In addition, a lower end of the cover device is located just above the workpiece 10 to capture as many chips as possible that fly past the guide element 6, for example. As shown in FIG. 4, a rear surface 11 of the cover device 8 which the chips strike has substantially the same slope with respect to the plane in which the lower end 7 of the guide element 6 is located as the upper end portion of the guide element 6.

The cover device 8 may be attached to the same holding apparatus as the guide element 6 or to a separate holding apparatus. The latter may make it possible for the cover device to also be used during conventional machining and when machining non-continuous grooves, the guide element 6 being located in the second position (cf. FIG. 3). As a result of the chips colliding with the rear surface 11 of the cover device, the chips can be directed along the deflection direction and captured and extracted by an optionally arranged extraction hood, which leads to even more effective reduction of the dust and chip contamination in the area around the machine.

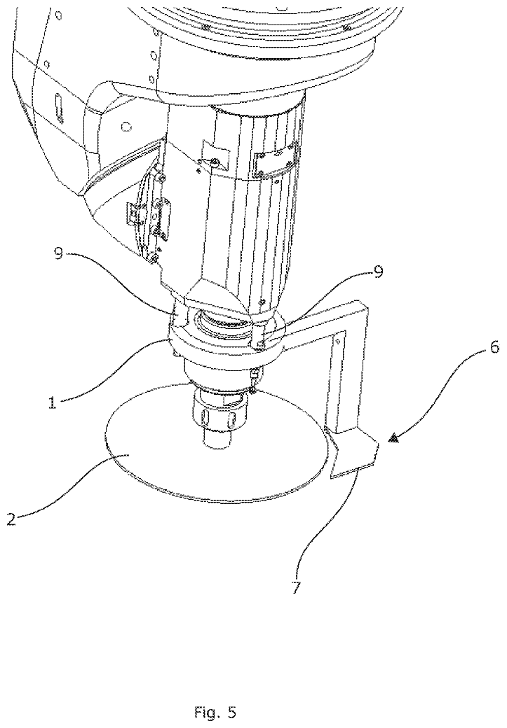

FIG. 5 shows a schematic perspective view of a preferred unit for machining a workpiece, in which the unit is attached to a 2-axis machining head (5-axis head). In this embodiment, the main body 1 has a different shape than in the embodiment shown in FIGS. 1, 3 and 4. Furthermore, compared to the embodiment shown in FIGS. 1, 3 and 4, the circular saw blade 2 and the guide element 6 are arranged in a different position with respect to the main body 1. However, the position of the guide element 6 with respect to the circular saw blade 2 is the same as in the embodiment shown in FIGS. 1, 3 and 4.

1. Unit for machining, in particular for machining grooves and separating cuts of a workpiece that preferably consists at least partially of wood, wood-based materials, metal materials or plastic, comprising
a main body (1),
a machining tool (2) that is mounted, in particular rotatably mounted, on the main body (1),
wherein the machining tool (2) has a first portion (3) which is configured such that, during the machining of the workpiece (10), it is able to penetrate into the workpiece (10),
a guiding device (4) which is arranged in the region preferably next to the machining tool (2) and is configured such that a medium is able to flow along, preferably through, the guiding device (4),
wherein the guiding device (4) has at least one opening (5) at a lower end portion thereof,
wherein the guiding device (4) is configured such that the medium is able to flow out of the opening (5) substantially towards the first portion (3) of the machining tool (2), and/or
wherein the guiding device (4) has an extraction device.

2. Unit according to claim 1,
wherein the guiding device (4) has at least one channel, wherein the channel has the opening (5) at the lower end portion of the guiding device (4).

3. Unit according to claim 1 or 2,
wherein the lower end portion of the guiding device (4) has at least one nozzle.

4. Unit according to one of the preceding claims, further comprising
a guide element (6) which is arranged in the region preferably next to the machining tool (2) and is configured such that particles, in particular chips, which can be separated from the workpiece (10) with the machining tool (2) during machining of said workpiece (10), can be guided along a deflection direction after separation from the workpiece (10),
wherein the deflection direction is substantially oblique to a reference direction (b), wherein the reference direction (b) is defined as a direction from the first portion (3) of the machining tool (2) to a second portion of the machining tool (2) which is opposite the first portion (3) of the machining tool (2).

5. Unit according to claim 4,
wherein the guide element (6) is configured such that a lower end (7) thereof, in a first position of the guide element (6), is arranged at a position which is located along the reference direction (b) within a region in which the first portion (3) of the machining tool (2) is located along the reference direction (b).

6. Unit according to claim 5,
wherein, in the first position of the guide element (6), a distance (d) along the reference direction (b) between the lower end (7) of the guide element (6) and an end of the machining tool (2), which forms part of the first portion (3) of the machining tool (2) and is furthest away, along the reference direction (b), from a mounting portion of the machining tool (2) at which the machining tool (2) is mounted on the main body (1), is less than 5 mm, preferably less than 3 mm, especially preferably less than 1 mm.

7. Unit according to claim 5 or 6,
wherein the guide element (6) can be controlled and/or adjusted from the first position into at least one second position, wherein the lower end (7) of the guide element (6) is arranged in the at least one second position at a position which is along the reference direction (b) outside the region in which the first portion (3) of the machining tool (2) is located along the reference direction (b).

8. Unit according to claim 7,
wherein a control and/or adjustment of the guide element (6) from the first position into the at least one second position takes place manually and/or automatically, wherein the control and/or adjustment of the guide element (6) takes place preferably pneumatically and/or electrically.

9. Unit according to one of claims 5 to 8,
wherein the guiding device (4) is arranged next to the guide element (6), wherein the at least one opening (5) is preferably arranged next to the lower end (7) of the guide element (6), preferably wherein the guiding device (4) is integrated in the guide element (6), wherein the at least one opening (5) is arranged preferably in the lower end (7) of the guide element (6) and/or in a lateral surface portion of the guide element (6) which preferably faces the machining tool (2) and is preferably located in the vicinity of the lower end (7) of the guide element (6).

10. Unit according to one of claims 4 to 9,
wherein the guide element (6) is configured as a riving knife.

11. Unit according to one of claims 4 to 10, further comprising
a cover device (8) which is arranged in the region of the guide element (6), preferably wherein the cover device (8) partially encloses the machining tool (2), wherein the cover device (8) is configured such that the particles can be guided along the deflection direction after separation from the workpiece (10).

12. Unit according to one of the preceding claims,
wherein a medium flow of the medium comprises in particular a particle flow, air flow, fluid flow and/or a flow of a mixture thereof.

13. Unit according to one of the preceding claims,
wherein the machining tool (2) has a circular saw blade.

14. Unit according to one of claims 4 to 13, further comprising
at least one, preferably at least two supports (9) to a C-axis or to a spindle housing and/or a hollow shank taper,
wherein the medium is fed via the at least one, preferably via the at least two supports (9) to a C-axis or to a spindle housing and/or via the hollow shank taper.

15. Exchangeable, preferably automatically exchangeable unit, in particular saw unit, comprising
the unit according to claim 14, wherein the unit is exchangeable into a 2-axis machining head (5-axis head) via the at least one, preferably via the at least two supports (9) and/or via the hollow shank taper, and the guide element (6) is automatically adjustable to a contour of the workpiece (10) according to a position of a C-axis and/or at least one additional axis, which is parallel or identical to a rotational axis of the machining tool (2), and a position of an A-axis of the 2-axis machining head (5-axis head).
